(19) United States
(12) Patent Application Publication
(10) Pub. No.: US 2013/0190418 A1
(43) Pub. Date: Jul. 25, 2013

(54) POLYETHERESTER POLYOLS AND PREPARATION THEREOF

(71) Applicants: Andreas Kunst, Ludwigshafen (DE); Berend Eling, Lemfoerde (DE); Christian Koenig, Mannheim (DE)

(72) Inventors: Andreas Kunst, Ludwigshafen (DE); Berend Eling, Lemfoerde (DE); Christian Koenig, Mannheim (DE)

(21) Appl. No.: 13/745,120

(22) Filed: Jan. 18, 2013

Related U.S. Application Data
(60) Provisional application No. 61/589,423, filed on Jan. 23, 2012.

(51) Int. Cl. C11C 3/04

(52) U.S. Cl. CPC C11C 3/04
USPC 521/157; 554/122

(57) ABSTRACT

The present invention relates to novel polyetherester polyols and to a process for preparation thereof.

The present invention relates to novel polyetherester polyols and to a process for preparation thereof.

Polyetherester polyols are polyols that include both polyether units and polyester units in one molecular chain. They are used inter alia as a raw material for the production of polyurethane materials. Various processes for obtaining polyetherester polyols are known in principle. Some relevant documents will now be cited:

U.S. Pat. No. 6,753,402 describes the catalytic addition of alkylene oxides onto polyesters by use of DMC catalysts.

U.S. Pat. No. 5,319,006, U.S. Pat. No. 5,436,313 and U.S. Pat. No. 5,696,225 describe the polycondensation of polyethers with dicarboxylic acids or anhydrides by use of polycondensation catalysts.

U.S. Pat. No. 6,569,352 describes a two-step method wherein an initial step comprises reacting polyols with cyclic anhydrides and a further step comprises adding the alkylene oxides onto the intermediate obtained in the initial step.

US 20070265367, U.S. Pat. No. 5,032,671 and Journal of Applied Polymer Science, volume 2007, issue 103, pages 417-424 describe the direct copolymerization of cyclic anhydrides and of cyclic esters, respectively, with alkylene oxide and alcohols as initiators.

US 20060211830 describes a two-step process wherein an initial step comprises reacting hydroxyl-containing carboxylic esters with alkylene oxide. The reaction product is subsequently condensed in the presence of a transesterification catalyst.

EP 1 923 417 B1 describes the reaction of H-functional compounds with alkylene oxides in the presence of fatty acid esters by assistance of basic catalysts. The process involves simultaneous alkoxylation and transesterification, so allegedly homogeneous polyetheresters are obtained.

Even though the use of fatty acid esters or carboxylic acids or carboxylic esters or carboxylic anhydrides as a raw material for the preparation of polyetherester polyols is described in the documents cited above, none of the documents states that the base-catalyzed ring-opening polymerization of alkylene oxides can involve further ester- or anhydride-functional molecules in addition to fatty acid esters. Yet this provides a way to obtain novel polyetherester structures which, via the choice of functional molecules, can be still further modified and optimized to the particular applications in polyurethane for example.

There are numerous applications, for example in relation to polyurethanes, which are obtainable from polyols, such as polyester polyols, where hydrophobic properties are desired. They generally lead to reduced imbibition of water and improved resistance to hydrolysis, i.e., improved aging characteristics on the part of the polyurethane. In addition, polyurethanes modified to be hydrophobic can have a changed surface texture, which can be reflected for example in improved slip resistance or in a more pleasant touch (improved haptics). Reduced water imbibition offers a clear advantage in coating, adhesive, sealant, elastomer (CASE) applications. These applications often specify a maximum water imbibition for the polyurethane under certain test conditions because it is known that polyurethanes having a comparatively low water imbibition usually have improved properties in these applications. Hydrophobic polyols are desirable in hydrocarbon-blown rigid polyurethane foam formulations because hydrophobic polyols improve the compatibility between the polyol component, the blowing agent and the isocyanate component in that even a comparatively high proportion of aliphatic or cycloaliphatic blowing agents (n-pentane or cyclopentane) will result in homogeneous polyol components.

However, the existing literature in the field of preparing polyetherester polyols, as embodied in the above-cited documents for example, fails to offer a satisfactory solution to the problem of how to prepare polyetherester polyols having hydrophobic properties for a wide range of applications. What is more, existing processes for preparing polyether-ester polyols generally have high energy requirements and are often very costly and inconvenient, for example since water formed in the course of the reaction has to be stripped off.

It is an object of the present invention to provide a simple and very energy-efficient process for preparing polyetherester polyols having hydrophobic properties for a wide range of applications. This process should ideally provide uniform and homogeneous polyetherester polyols which should be useful for polyurethane (PU) applications. It should be possible to use inexpensive raw materials.

We have found that this object is achieved by the process for preparing a polyetherester polyol by reacting a mixture (A) comprising at least one Zerevitinov-active compound i), at least one compound ii), selected from the group comprising cyclic anhydrides of dicarboxylic acids, at least one fatty acid iiia) and/or its ester iiib) and also optionally at least one compound iv), selected from the group comprising cyclic mono- and diesters, with at least one alkylene oxide v) by means of a nucleophilic and/or basic catalyst, wherein the at least one Zerevitinov-active compound i) is selected from the group of hydroxyl- and/or amino-functional compounds having a functionality in the range between 1 and 8, and wherein said fatty acid ester iiib) is selected from the group comprising fatty acid esters comprising no hydroxyl groups, and mixtures thereof.

The invention further also provides a polyetherester polyol obtainable by the process of the present invention, and also for the use of a polyetherester polyol obtainable by the process of the present invention for production of foamed and/or compact polyurethanes by reaction with a di- or polyisocyanate, and also for the use of a polyetherester polyol obtainable by the process of the present invention for production of polyisocyanurate foams, and for the use of a polyetherester polyol obtainable by the process of the present invention for production of compact polyurethanes from the sector of coatings or adhesives.

In one preferred embodiment of the invention, said mixture (A) is initially charged to the reaction vessel together with the nucleophilic and/or basic catalyst before the at least one alkylene oxide iv) is added.

In one preferred embodiment of the invention, the Zerevitinov-active compound i) is selected from the group of hydroxyl- and/or amino-functional compounds having a functionality in the range between 1 and 8.

The Zerevitinov-active compound i) in a further preferred embodiment is selected from the group of typically used polyalcohols or mono- and polyamines having functionalities in the range between 2 to 8 or reaction products thereof with alkylene oxides such as propylene oxide or ethylene oxide and also mixtures thereof. As examples there may be mentioned here water, propylene glycol, ethylene glycol, diethylene glycol, dipropylene glycol, neopentylglycol, 1,2-butanediol, 1,3-butanediol, 1,4-butanediol, hexanediol, pentanediol, 3-methyl-1,5-pentanediol, 1,12-dodecanediol, glycerol, trimethylolpropane, triethanolamine, pentaerythritol, sorbitol, sucrose, hydroquinone, pyrocatechol, resorcinol, bisphenol A, bisphenol F, 1,3,5-trihydroxybenzene, condensation products of formaldehyde with phenol or melamine or urea which bear methylol groups, urea, biuret, Mannich bases, starch or starch derivatives, ammonia, ethanolamine, diethanolamine, triethanolamine, isopropanolamine, diisopropanolamine, triisopropanolamine, ethylenediamine, hexamethylenediamine, aniline, all isomers of diaminobenzene, diaminotoluene and also diaminodiphenylmethane.

The Zerevitinov-active compound is preferably selected from the group comprising glycerol, propylene glycol, dipropylene glycol, ethylene glycol, diethylene glycol, neopentylglycol, trimethylolpropane, sucrose, sorbitol, pentaerythritol and bisphenol A and also mixtures thereof.

In one embodiment of the process according to the present invention, the cyclic anhydride ii) of a dicarboxylic acid is selected from the group comprising a) alkenylsuccinic anhydrides, b) phthalic anhydride, c) maleic anhydride, d) succinic anhydride and e) tetrahydrophthalic anhydride, and also mixtures thereof.

The alkenylsuccinic anhydrides a) are preferably selected from the group of C12-C20-alkyl-chain-substituted succinic anhydrides and poly(isobutylene)succinic anhydrides of molecular weight between 500 and 2000 g/mol. The at least one alkenylsuccinic anhydride a) in one embodiment of the process according to the present invention is preferably selected from the group comprising C18- and/or C16-alkenylsuccinic anhydrides, poly(isobutylene)succinic anhydride and mixtures thereof.

The cyclic anhydride ii) of a dicarboxylic acid can also be itaconic acid in one embodiment.

In one embodiment of the process according to the present invention, the at least one alkylene oxide v) is selected from the group comprising propylene oxide, ethylene oxide, 1,2-butylene oxide, 2,3-butylene oxide, 1,2-pentene oxide, 1-octene oxide, 1-decene oxide, 1-dodecene oxide, 1-tetradecene oxide, 1-hexadecene oxide, 1-octadecene oxide, styrene oxide, cyclohexene oxide, epoxypropyl neododecanoate, glycidol, epichlorohydrin and mixtures thereof.

The alkylene oxide v) is preferably selected from the group 1,2-butylene oxide, propylene oxide, ethylene oxide.

In one embodiment of the process according to the present invention, the fatty acid iiia) is selected from the group comprising hydroxyl-containing fatty acids, hydroxyl-modified fatty acids and fatty acids comprising no hydroxyl groups, and mixtures thereof.

In a further embodiment of the process according to the present invention, the fatty acid iiia) is selected from the group comprising saturated and unsaturated fatty acids, and also mixtures thereof.

The fatty acid iiia) in a further embodiment is selected from the group comprising saturated, monounsaturated, diunsaturated and triunsaturated fatty acids, non-hydroxyl-containing fatty acids, hydroxyl-containing fatty acids and also hydroxyl-modified fatty acids. The fatty acid iiia) is preferably selected from the group comprising butyric acid, caproic acid, caprylic acid, capric acid, lauric acid, myristic acid, palmitic acid, stearic acid, oleic acid, ricinoleic acid, linoleic acid, linolenic acid, arachidonic acid, eicosapentaenoic acid, docosahexaenoic acid, hydroxyl-modified oleic acid, hydroxyl-modified linoleic acid, hydroxyl-modified linolenic acid and hydroxyl-modified ricinoleic acid.

The term “fatty acid ester” within the meaning of component iiib) of the present invention relates to mono-, di-, triesters or polyesters of fatty acids; the aforementioned triesters of fatty acids are also referred to as triglycerides. Triglycerides are main constituents of natural fats or oils, which can be both of vegetable and of animal origin. Polyesters of fatty acids for the purposes of the invention are polyalcohols polyesterified with fatty acids.

Therefore, the fatty acid ester iiib) is selected from the group comprising fatty acid triglycerides, fatty acid alkyl esters with and without hydroxyl functionalities.

In one embodiment, the fatty acid ester iiib) is selected from the group comprising hydroxyl-containing fatty acid esters, hydroxyl-modified fatty acid esters and fatty acid esters comprising no hydroxyl groups, and mixtures thereof.

Useful hydroxyl-containing fatty acid esters include, for example, ricinoleic esters or else fatty acid mono- or polyesters of polyfunctional alcohols, for example of oligo- or polysaccharides.

In one embodiment of the invention, the fatty acid ester iiib) is selected from the group comprising cocoa butter, coconut fat, cottonseed oil, peanut oil, hazelnut oil, walnut oil, linseed oil, safflower oil, marine animal fat (train oil), pork fat, beef tallow, goose fat, butter fat, castor oil, soybean oil, rapeseed oil, olive oil, sunflower oil, palm oil, grape seed oil, black cumin oil, pumpkin seed oil, maize germ oil, wheatgerm oil, almond oil, pistachio oil, apricot kernel oil, macadamia nut oil, avocado oil, sea buckthorn oil, sesame oil, hemp oil, primula oil, wild rose oil, hydroxyl-modified soybean oil, hydroxyl-modified rapeseed oil, hydroxyl-modified olive oil, hydroxyl-modified sunflower oil and derivatized castor oil.

In a preferred embodiment, the fatty acid ester iiib) is selected from the group comprising train oil, tallow, castor oil, soybean oil, rapeseed oil, olive oil, sunflower oil, hydroxyl-modified soybean oil, hydroxyl-modified rapeseed oil, hydroxyl-modified olive oil, hydroxyl-modified sunflower oil and derivatized castor oil, palm oil, hydroxyl-modified palm oil, and mixtures thereof.

The fatty acid ester iiib) in one embodiment is preferably selected from the group castor oil, soybean oil, palm oil, rapeseed oil, sunflower oil, hydroxyl-modified oils, unsaturated and/or saturated C4-C22 fatty acid alkyl esters such as, for example, alkyl stearates, alkyl oleates, alkyl linoleates, alkyl linolenates, alkyl ricinoleates or mixtures thereof. It is very particularly preferable for the fatty acid ester iiib) to be selected from the group castor oil, soybean oil, rapeseed oil, sunflower oil, palm oil, hydroxyl-modified soybean oil, hydroxyl-modified sunflower oil, hydroxyl-modified palm oil, hydroxyl-modified rapeseed oil and methyl and/or ethyl esters of the preferred fatty acid esters.

Introducing the hydroxyl groups into the hydroxyl-modified oils or into the hydroxyl-modified fatty acids can be effected via the generally known processes such as, for example, via hydroformylation/hydrogenation or epoxidation/ring opening or ozonolysis, direct oxidation, nitrous oxide oxidation/reduction.

In one embodiment of the process according to the present invention, compound iv) is not present.

In a further embodiment of the process according to the present invention, at least one compound iv) is present.

This compound iv) is preferably selected from the group comprising y-butyrolactone, δ-valerolactone, ε-caprolactone, (R,R)-lactide, (S,S)-lactide, meso-lactide and also mixtures thereof; it is particularly preferable for compound iv) to be c-caprolactone.

The basic and/or nucleophilic catalyst may be selected from the group alkali metal or alkaline earth metal hydroxides, alkali metal or alkaline earth metal alkoxides, tertiary amines, N-heterocyclic carbenes.

The basic and/or nucleophilic catalyst is preferably selected from the group comprising tertiary amines.

It is particularly preferable for the basic and/or nucleophilic catalyst to be selected from the group comprising imidazole and imidazole derivatives, and imidazole is very particularly preferred.

In another preferred embodiment, the basic and/or nucleophilic catalyst is selected from the group comprising N-heterocyclic carbenes and more preferably from the group comprising N-heterocyclic carbenes based on N-alkyl- and N-aryl-substituted imidazolylidenes.

In a preferred embodiment, the basic and/or nucleophilic catalyst is selected from the group comprising trimethylamine, triethylamine, tripropylamine, tributylamine, N,N′-dimethylethanolamine, N,N′-dimethylcyclohexylamine, dimethylethylamine, dimethylbutylamine, N,N′-dimethylaniline, 4-dimethylaminopyridine, N,N′-dimethylbenzylamine, pyridine, imidazole, N-methylimidazole, 2-methylimidazole, 4-methylimidazole, 5-methylimidazole, 2-ethyl-4-methylimidazole, 2,4-dimethylimidazole, 1-hydroxypropylimidazole, 2,4,5-trimethylimidazole, 2-ethylimidazole, 2-ethyl-4-methylimidazole, N-phenylimidazole, 2-phenylimidazole, 4-phenylimidazole, guanidine, alkylated guanidine, 1,1,3,3-tetramethylguanidine, 7-methyl-1,5,7-triazabicyclo[4.4.0]dec-5-ene, 1,5-diazobicyclo[4.3.0]-non-5-ene, 1,5-diazabicyclo[5.4.0]undec-7-ene, preferably imidazole and dimethylethanolamine (DMEOA).

The catalysts mentioned can be used alone or in any desired mixtures relative to each other.

The process for preparing the polyetherester polyols is preferably carried out by initially charging the Zerevitinov-active compound to a reactor together with the dicarboxylic anhydride ii) and also the fatty acid iiia) and/or the fatty acid ester iiib) and the basic catalyst and adding the alkylene oxide by continuously metering it into the reactor. In a further embodiment of the invention, the Zerevitinov-active compound i) and/or the dicarboxylic anhydride ii) and/or the fatty acid ester iiib) and/or the fatty acid iiia) is likewise continuously metered into the reactor together with the alkylene oxide. In a further embodiment, all the components are added simultaneously or in succession during the synthesis by metering and the reaction product is removed continuously, so that the entire process can be carried out in a fully continuous manner.

The reaction with alkylene oxide is typically carried out at temperatures in the range between 80 and 200° C., preferably between 100° C. and 160° C. and more preferably at between 110° C. and 140° C.

When tertiary amines and/or N-heterocyclic carbenes are used as catalysts for the reaction with alkylene oxides, the catalyst concentration is between 50-5000 ppm and preferably between 100 and 1000 ppm, based on the mass of the end product, and the catalyst need not be removed from the reaction product after the reaction.

In a preferred embodiment, the Zerevitinov-active compound i) is selected from the group trimethylolpropane, glycerol, neopentylglycol, bisphenol A and the cyclic anhydride of a carboxylic acid ii) is selected from the group of C18- and/or C16-alkenylsuccinic anhydrides and the fatty acid ester iiib) is selected from the group castor oil, soybean oil, palm oil and the alkylene oxide v) is propylene oxide and the basic and/or nucleophilic catalyst is selected from the group dimethylethanolamine (DMEOA) and imidazole.

In a further preferred embodiment, the Zerevitinov-active compound i) is selected from the group ethylene glycol, diethylene glycol, propylene glycol, dipropylene glycol, glycerol and trimethylolpropane and the cyclic anhydride of a carboxylic acid ii) is phthalic anhydride and the fatty acid iiia) is selected from the group oleic acid, stearic acid, linoleic acid, linolenic acid or mixtures thereof and the fatty acid ester iiib) is selected from the group castor oil, soybean oil, palm oil and tallow and the alkylene oxide v) is propylene oxide or ethylene oxide or mixtures thereof and the basic and/or nucleophilic catalyst is selected from the group dimethylethanolamine (DMEOA) and imidazole.

The polyetherester polyols of the present invention are prepared by ring-opening polymerization of alkylene oxides. They are telechels and have a well-defined molecular weight and functionality. The functionality is generally in the range between 1-8, preferably between 2-6 and more preferably between 2-4, coupled with OH numbers in the range between 20 and 1000 mgKOH/g, preferably between 20 and 800 mgKOH/g and more preferably between 100 and 600 mgKOH/g.

The polyetherester polyols of the present invention preferably comprise between 5% by mass and 90% by mass of units derived from fatty acids iiia) and/or fatty acid esters iiib), preferably 5 to 80 mass percent, depending on the intended use.

The polyetherester polyols of the present invention preferably comprise between 5% by mass and 80% by mass of units derived from compound ii), depending on the intended purpose.

The basic and/or nucleophilic catalysts used can catalyze not only the ring-opening polymerization but additionally also the transesterification of the anhydride-functional molecules, which produces uniform reaction products. Product properties are no longer greatly influenced by process parameters and the products have better reproducibility.

One advantage of the process according to the present invention is that a homogeneous reaction product is even obtainable from compounds that are notable for a very large difference in polarity and thus are mutually incompatible in pure form. The reaction with alkylene oxide renders the mutually incompatible molecules compatible and produces homogeneous reaction products comprising not only polyether units but also polyester units. In the case of base-cataylzed alkoxylation, one reason for this is, as mentioned, believed to be that transesterification reactions take place in the process at the same time as the ring-opening polymerization and ensures the homogeneous distribution of the ester-bearing molecular chains with the ether-bearing molecular chains.

The process according to the present invention also offers the advantage that it can be carried out at lower temperatures than comparable conventional processes (and thus is energy-saving), and that it is not only more time-efficient but also delivers a higher yield.

The utility of the polyethesterols according to the present invention for polyurethane (PU) parts is very diverse. For example, they can be used in foamed or compact PU materials such as, for example, in packaging foams, flexible foams, rigid foams, semi-rigid foams, carpet foams, integral foams, shoe soles, motor vehicle bumpers and other motor vehicle exterior parts, artificial leathers, coatings, adhesives, sealants or elastomers.

The polyols of the invention are obtainable in a hydroxyl value range where these polyols, when used as main polyol in the polyurethane system, are more suitable for comparatively rigid polyurethanes, such as rigid foam, coatings, adhesives and sealants.

Rigid foams, as mentioned above, can be polyurethane or polyisocyanurate foams. The polyols of the invention have additional advantages when alkanes, e.g. pentane, are used as blowing agents: the incorporation of hydrophobic oil-based side chains by the use of triglycerides and anhydrides comprising a hydrophobic side chain increases the pentane compatibility of the system. It is similarly possible to incorporate aromatic structures, by use of phthalic anhydride for example, to increase the fire resistance of the foam.

The ester groups introduced into the polyols by using triglycerides and anhydrides in the synthesis also provide an additional increase in fire resistance. This makes the polyols of the invention particularly useful for applications in the rigid-foam sector.

In the sector of coatings, adhesives and sealants, the incorporation of hydrophobic oil-based side chains and anhydrides comprising a hydrophobic side chain leads to enhanced hydrophobicity. Enhanced hydrophobicity has advantages in the production of the polyurethane and in its properties. A long (open) pot life can be desirable to produce the polyurethane in applications mentioned above. Enhanced hydrophobicity on the part of the polyurethane mixture reduces moisture imbibition during the reaction, lengthening the pot life of the system and reducing the formation of bubbles. Enhanced hydrophobicity leads to enhanced water repellency in the final properties of the fully reacted polyurethane. The imbibition of water can reduce the hardness of the polyurethane and the adherence of the polyurethane to substrates. A polyurethane of comparatively low water imbibition is likewise desired in sheathings of electronic components, since the imbibition of water leads to an increase in the dielectric constant and a decrease in volume resistivity. Moreover, hydrophobic polyurethanes are less susceptible to hydrolysis and consequently the properties of the polyurethane remain intact for longer.

The polyols of the present invention can be used for the production of prepolymers by reaction with diisocyanates. Thus, the polyols of the present invention can be used for the production of polyurethane materials not only directly in the polyol component of the combination but also in the form of a prepolymer. In this case, the prepolymer fraction in the prepolymer-polyol mixture can be between 10% to 90%. These prepolymer-polyol mixtures are used, for example, when the polyols of the present invention are used in single-component moisture-curing systems such as for coating, adhesive and sealant materials for example.

Products for a wide variety of applications can be produced, depending on which feedstocks are used. Polyols for polyurethane coatings or for rigid polyurethane foams, for example, preferably utilize an alkenylsuccinic anhydride as component ii) and a fatty acid triglyceride such as castor oil as component iiib).

In the case of rigid polyisocyanurate-polyurethane foams, component ii) is preferably phthalic anhydride and component iiib) is preferably soybean oil or methyl oleate.

The polyetherester polyols obtained by the process according to the present invention comprise hydrophobic components, which can be incorporated in the product either via the fatty acid ester iiib) or via the anhydride component ii), and so can offer the abovementioned advantages of hydrophobic polyols in the polyurethane. As already mentioned by way of example, the properties can be adjusted to various applications by choosing the type and amount of components i), ii), iii), iv) and v).

### EXAMPLES

The examples which follow illustrate some aspects of the present invention; they are not in any way intended to restrict the scope of the invention.

### Polyetherester Polyol Example A

405.5 g of trimethylolpropane, 3379.4 g of castor oil, 495.4 g of phthalic anhydride and 1.5 g of imidazole were initially charged to a pressure autoclave and while stirring were inertized with nitrogen three times. The reaction mixture was then heated to 120° C. and admixed with 722.5 g of propylene oxide added in 120 minutes. On completion of the monomer addition and on reaching a constant reactor pressure, volatiles were then distilled off in vacuo for about 30 minutes under nitrogen stripping and then the product was discharged to obtain 4855 g of a viscous monophasic polyetheresterol. The product had the following analytical parameters:

| | |
|---|---|
| Hydroxyl value: 210 mgKOH/g | (DIN 53240) |
| Viscosity (at 25° C.): 2070 mPas | (DIN 51550) |
| Water content: 0.007% | (DIN 51777) |
| Acid number: <0.01 mgKOH/g | (DIN 53402) |

### Polyetherester Polyol Example B

449.9 g of trimethylolpropane, 3752.5 g of castor oil, 509.9 g of Pentasize 68 (C16/C18-alkenylsuccinic anhydride from Trigon GmbH) and 1.5 g of imidazole were initially charged to a pressure autoclave and while stirring were inertized with nitrogen three times. The reaction mixture was then heated to 120° C. and admixed with 290 g of propylene oxide added in 60 minutes. On completion of the monomer addition and on reaching a constant reactor pressure, volatiles were then distilled off in vacuo for about 30 minutes under nitrogen stripping and then the product was discharged to obtain 4951 g of a viscous monophasic polyetheresterol. The product had the following analytical parameters:

| | |
|---|---|
| Hydroxyl value: 234 mgKOH/g | (DIN 53240) |
| Viscosity (at 25° C.): 1348 mPas | (DIN 51550) |
| Water content: 0.014% | (DIN 51777) |
| Acid number: <0.054 mgKOH/g | (DIN 53402) |

### Polyetherester Polyol Example C

449.6 g of trimethylolpropane, 3746.3 g of castor oil, 250.0 g of Glissopal SA (poly(isobutylene)succinic anhydride of molecular weight 1000 g/mol from BASF SE) and 1.5 g of imidazole were initially charged to a pressure autoclave and while stirring were inertized with nitrogen three times. The reaction mixture was then heated to 120° C. and admixed with 799.2 g of propylene oxide added in 120 minutes. On completion of the monomer addition and on reaching a constant reactor pressure, volatiles were then distilled off in vacuo for about 30 minutes under nitrogen stripping and then the product was discharged to obtain 4928.4 g of a viscous, homogeneous, slightly cloudy polyetheresterol. The product had the following analytical parameters:

| | |
|---|---|
| Hydroxyl value: 225 mgKOH/g | (DIN 53240) |
| Viscosity (at 25° C.): 1071 mPas | (DIN 51550) |
| Water content: 0.014% | (DIN 51777) |
| Acid number: 0.01 mgKOH/g | (DIN 53402) |

### Polyetherester Polyol Example D

449.6 g of trimethylolpropane, 3746.3 g of castor oil, 250.1 g of Pentasize 8 (C16/C18-alkenylsuccinic anhydride from Trigon GmbH) and 1.53 g of imidazole and 0.053 g of Ti(IV) tert-butoxide were initially charged to a pressure autoclave and while stirring were inertized with nitrogen three times. The reaction mixture was then heated to 120° C. and admixed with 801.1 g of propylene oxide added in 120 minutes. On completion of the monomer addition and on reaching a constant reactor pressure, volatiles were then distilled off in vacuo for about 30 minutes under nitrogen stripping and then the product was discharged to obtain 5140 g of a viscous monophasic polyetheresterol. The product had the following analytical parameters:

| | |
|---|---|
| Hydroxyl value: 225 mgKOH/g | (DIN 53240) |
| Viscosity (at 25° C.): 1031 mPas | (DIN 51550) |
| Water content: 0.01% | (DIN 51777) |
| Acid number: 0.01 mgKOH/g | (DIN 53402) |

### Polyetherester Polyol Example E

1390.2 g of dipropylene glycol, 1751.8 g of phthalic anhydride, 1004.2 g of soybean oil and 1.53 g of imidazole were initially charged to a pressure autoclave and while stirring were inertized with nitrogen three times. The reaction mixture was then heated to 120° C. and admixed with 855.8 g of ethylene oxide added in 120 minutes. On completion of the monomer addition and on reaching a constant reactor pressure, volatiles were then distilled off in vacuo for about 30 minutes under nitrogen stripping and then the product was discharged to obtain 4914 g of a viscous monophasic polyetheresterol. The product had the following analytical parameters:

| | |
|---|---|
| Hydroxyl value: 241.3 gKOH/g | (DIN 53240) |
| Viscosity (at 25° C.): 1724 mPas | (DIN 51550) |
| Water content: 0.036% | (DIN 51777) |
| Acid number: 0.01 mgKOH/g | (DIN 53402) |

### Polyetherester Polyol Example F

1101.0 g of diethylene glycol, 1749.5 g of phthalic anhydride, 1000.2 g of soybean oil and 1.5 g of imidazole were initially charged to a pressure autoclave and while stirring were inertized with nitrogen three times. The reaction mixture was then heated to 120° C. and admixed with 1150.6 g of propylene oxide added in 180 minutes. On completion of the monomer addition and on reaching a constant reactor pressure, volatiles were then distilled off in vacuo for about 30 minutes under nitrogen stripping and then the product was discharged to obtain 4940 g of a viscous monophasic polyetheresterol. The product had the following analytical parameters:

| | |
|---|---|
| Hydroxyl value: 238 mgKOH/g | (DIN 53240) |
| Viscosity (at 25° C.): 1784 mPas | (DIN 51550) |
| Water content: 0.016% | (DIN 51777) |
| Acid number: 0.01 mgKOH/g | (DIN 53402) |

### Polyetherester Polyol Example G

1108.9 g of sucrose, 336.3 g of glycerol, 233.9 g of castor oil, 19.06 g of water, 100 g of Pentasize 68 (C16/C18-alkenylsuccinic anhydride from Trigon GmbH) and 5.0 g of imidazole were initially charged to a pressure autoclave and while stirring were inertized with nitrogen three times. The reaction mixture was then heated to 130° C. and admixed with 3306.3 g of propylene oxide added in 7 hours. On completion of the monomer addition and on reaching a constant reactor pressure, volatiles were then distilled off in vacuo for about 30 minutes under nitrogen stripping and then the product was discharged to obtain 5014 g of a viscous monophasic polyetheresterol. The product had the following analytical parameters:

| | |
|---|---|
| Hydroxyl value: 414 mgKOH/g | (DIN 53240) |
| Viscosity (at 25° C.): 14206 mPas | (DIN 51550) |
| Water content: 0.022% | (DIN 51777) |
| Acid number: 0.04 mgKOH/g | (DIN 53402) |

It is clear from these examples that the polyetherester polyols of the present invention are obtainable by a simple process and that the process leads to uniform and homogeneous reaction products for a wide range of applications.

Use examples 1-2: Coating applications.

| | |
|---|---|
| Antifoam MSA | defoamer from Dow Corning |
| Jeffcat TD-33 A | triethylenediamine in dipropylene glycol with an OH |
| | number: 560 mgKOH/g from Huntsman |
| Zeolitpaste | molecular sieve in castor oil from Uop |
| isocyanate | polymer MDI (Lupranate ®) M20S from BASF SE |

Plate Production for Mechanical Testing

The reaction components and additives are stored and processed at room temperature. The polyol component (component A, see tables) is made up and mixed in a Speedmixer® for two minutes. It is then left to stand for at least 30 minutes. The amount of isocyanate added is calculated such that the isocyanate index is 115.9. The A component is mixed with the isocyanate in the Speedmixer® for 60 s. The mixture is poured into an open mold measuring 30×20×0.2 cm³ and smoothed. The resulting plate remains in the mold for one hour before it is removed. The plates are subsequently conditioned at 80° C. for two hours. The next day, suitable samples are taken to determine the mechanical properties.

Swell Test:

A piece measuring 4×4 cm² is cut out of the 2 mm plate and weighed to determine its mass (m1). The sample is then placed into a water-filled 6 L bucket, which is left in a heated thermal cabinet at 100° C. for 5 hours. To prevent the samples from drifting upwardly, they are clamped in a metal frame. After the samples were removed, lightly dried with cellulose and cooled down to room temperature, the mass is determined (m2) and used to calculate the degree of swelling in percent using [((m2−m1)/m1)×100%]. The experimental error is below 0.1%. Differences of 0.2% between the measurements are significant.

Use Examples 1 and 2

| isocyanate | Lupranat M20S |
|---|---|
| index | 115.9 |

| Example | | 1 | 2 | |
|---|---|---|---|---|
| Zeolitpaste | parts | 6.95 | 6.95 | |
| Antifoam MSA | parts | 0.05 | 0.05 | |
| Jeffcat TD-33 A | parts | 0.3 | 0.25 | |
| polyol C | parts | 93 | | |
| polyol D | parts | | 93 | |
| Lupranat M20S | MV | 100/60.2 | 100/59.6 | |
| 2 mm plate | | | | determination to |
| tongue tear resistance | N/mm | 59.2 | 63.5 | DIN ISO 34-1, B(b) |
| tensile strength | MPa | 25 | 26.4 | DIN EN ISO 527 |
| elongation at break | % | 50 | 51 | DIN EN ISO 527 |
| modulus of elasticity | MPa | 467.3 | 384.4 | DIN EN ISO 527 |
| hardness | Shore D | 72 | 71 | DIN 53505 |
| degree of swelling | % of plate | 0.59 | 0.58 | |

MV describes the mixing behavior of A to B component.

Use examples 1 and 2 show that the inventive polyols provide polyurethanes having properties which are typical of coating applications.

Use Examples 3-4: Rigid-foam applications.

| | |
|---|---|
| TCPP | flame retardant (tri-2-chloroisopropyl phosphate) |
| PEG 600 | polyethylene glycol with Mw: 600 g/mol |
| Tegostab B 8443 | stabilizer from GE Bayer Silicones |
| Texacat ZF 22 | bis(2-dimethylaminoethyl) ether in dipropylene |
| | glycol with an OH number of 250 mgKOH/g |
| | from Huntsman. |
| Dabco K 2097 | catalyst based on potassium acetate and having an |
| | OH number of 740 mgKOH/g from Air Products |
| n-pentane | physical blowing agent from Haltermann |
| tap water | |
| isocyanate | polymer MDI (Lupranat ®) M20R from BASF SE |

Foam Production for Mechanical Testing

A partly water, partly pentane-blown polyisocyanurate system is taken as the base foam system. A catalyst based on potassium acetate is taken to form the isocyanurate groups. The amount of pentane and water is determined such that the foam had a free-rise density of about 31 kg/m³; the amount of catalysts is determined such that the foam had a gel time of about 50 seconds. The reaction components and additives are stored and processed at room temperature. The polyol component is made up and stirred by hand using a laboratory stirrer. The A components are left to stand for half an hour, so most of the air bubbles in the mixture can escape. The amount of isocyanate added is calculated such that the isocyanate index is 225. The A component is mixed with the isocyanate for six seconds by hand using a laboratory stirrer. The mixture is poured into an 11 L metallic cube mold with a ten percent overpack relative to the free-rise density and the mold is closed. After half an hour, the cube foam is demolded. The foam samples are stored at room temperature for 3 days and are then sawn into test specimens for the mechanical tests.

| Example | | 3 | 4 | |
|---|---|---|---|---|
| TCPP | parts | 13.0 | 13.0 | |
| PEG 600 | parts | 6.0 | 6.0 | |
| Tegostab B 8443 | parts | 2.0 | 2.0 | |
| tap water | parts | 2.1 | 2.1 | |
| polyol E | parts | 78.5 | | |
| polyol F | parts | | 78.5 | |
| Texacat ZF 22 | parts | 2.1 | 2.1 | |
| Dabco K 2097 | parts | 1.6 | 1.6 | |
| n-pentane | parts | 13.5 | 13.5 | |
| Beaker test | | | | |
| Cream time | s | 11 | 11 | |
| Fiber time | s | 45 | 51 | |
| Full rise time | s | 77 | 81 | |
| Apparent density | kg/m³ | 31.3 | 32 | |
| Cube | | | | determination to DIN |
| | | | | standard |
| Core density | kg/m³ | 30.1 | 32.5 | DIN 53421/DIN EN ISO 604 |
| Closed-cell content | % | 90 | 87 | DIN ISO 4590 |
| Compressive | N/mm² | 0.21 | 0.21 | DIN 53421/DIN EN ISO 604 |
| strength | | | | |
| Flexural strength/-sp. | N/mm² | 0.27 | 0.21 | DIN 53423 |
| Sag | mm | 7.8 | 9.0 | DIN 53423 |
| Dimensional stability | | | | DIN ISO 2796 |
| test (−30° C.) | | | | |
| Length change | % | −0.2 | −0.2 | |
| Width change | % | −0.1 | 0.1 | |
| Height change | % | 0.0 | 0.1 | |
| Dimensional stability | | | | DIN ISO 2796 |
| test (80° C.) | | | | |
| Length change | % | 0.0 | −0.3 | |
| Width change | % | 0.3 | −0.9 | |
| Height change | % | −0.8 | 0 | |

Use examples 3 and 4 show that the inventive polyols provide rigid foams having typical rigid-foam apparent densities and physical properties.

We claim:

1. The process for preparing a polyetherester polyol by reacting a mixture (A) comprising at least one Zerevitinov-active compound i), at least one compound ii), selected from the group comprising cyclic anhydrides of dicarboxylic acids, at least one fatty acid ester iiib) and also optionally at least one compound iv), selected from the group comprising cyclic mono- and diesters, with at least one alkylene oxide v) by means of a nucleophilic and/or basic catalyst, wherein the at least one Zerevitinov-active compound i) is selected from the group of hydroxyl- and/or amino-functional compounds having a functionality in the range between 1 and 8, and wherein said fatty acid ester iiib) is selected from the group comprising fatty acid esters comprising no hydroxyl groups, and mixtures thereof.

2. The process according to claim 1 wherein said mixture (A) is initially charged to the reaction vessel together with the nucleophilic and/or basic catalyst before the at least one alkylene oxide v) is added.

3. The process according to either of claims 1 and 2 wherein said cyclic anhydride ii) of a dicarboxylic acid is selected from the group comprising a) alkenylsuccinic anhydrides, b) phthalic anhydride, c) maleic anhydride, d) succinic anhydride and e) tetrahydrophthalic anhydride, and also mixtures thereof.

4. The process according to claim 3 wherein the at least one alkenylsuccinic anhydride a) is selected from the group comprising C18- and/or C16-alkenylsuccinic anhydrides, poly(isobutylene)succinic anhydride and mixtures thereof.

5. The process according to any of claims 1 to 4 wherein the at least one alkylene oxide v) is selected from the group comprising propylene oxide, ethylene oxide, 1,2-butylene oxide, 2,3-butylene oxide, 1,2-pentene oxide, 1-octene oxide, 1-decene oxide, 1-dodecene oxide, 1-tetradecene oxide, 1-hexadecene oxide, 1-octadecene oxide, styrene oxide, cyclohexene oxide, glycidol, epichlorohydrin and mixtures thereof, preferably propylene oxide, ethylene oxide and butylene oxide and mixtures thereof.

6. The process according to any of claims 1 to 5 wherein said fatty acid ester iiib) is selected from the group comprising train oil, tallow, soybean oil, rapeseed oil, olive oil, sunflower oil and mixtures thereof.

7. The process according to any of claims 1 to 6 wherein said compound iv) is not present.

8. The process according to any of claims 1 to 6 wherein at least one compound iv) is present.

9. The process according to claim 8 wherein at least one compound iv) is selected from the group comprising y-butyrolactone, δ-valerolactone, ε-caprolactone, (R,R)-lactide, (S,S)-lactide, meso-lactide and also mixtures thereof.

10. The process according to claim 8 wherein said compound iv) is ε-caprolactone.

11. The process according to any of claims 1 to 10 wherein the nucleophilic and/or basic catalyst is selected from the group comprising tertiary amines.

12. The process according to any of claims 1 to 10 wherein the nucleophilic and/or basic catalyst is selected from the group comprising N-heterocyclic carbenes.

13. The process according to any of claims 1 to 11 wherein the basic catalyst is selected from the group comprising imidazole and imidazole derivatives, preferably imidazole.

14. The process according to any of claims 1 to 13, wherein the polyetherester polyol has a hydroxyl number in the range between 20 and 1000 mgKOH/g, preferably in the range from 100 to 600 mgKOH/g.

15. The process according to any of claims 1 to 14 wherein the polyetherester polyol comprises between 5% and 90 wt% of units derived from fatty acid ester iiib).

16. The process according to any of claims 1 to 14 wherein the polyetherester polylol comprises between 5% and 80 wt% of units derived from compound ii).

17. The process according to any of claims 1 to 16 wherein the reaction with alkylene oxide v) is carried out at temperatures in the range between 80° and 200° C.

18. The process according to any of claims 1 to 17 conducted as a semi-batch process or as a continuous process.

19. A polyetherester polyol obtainable by the process of any of claims 1 to 18.

20. The use of a polyetherester polyol obtainable by the process of any of claims 1 to 18 for production of foamed and/or compact polyurethanes by reaction with a di- or polyisocyanate.

21. The use of a polyetherester polyol obtainable by the process of any of claims 1 to 18 for production of polyisocyanurate foams.

22. The use of a polyetherester polyol obtainable by the process of any of claims 1 to 18 for production of compact polyurethanes from the sector of coatings or adhesives.
